(19) United States
(12) Patent Application Publication
(10) Pub. No.: US 2007/0293794 A1
(43) Pub. Date: Dec. 20, 2007

(54) MASSAGING/CLEANSING DEVICE

(76) Inventors: Jim Siegrest, Cathedral City, CA (US); Cece Baum, Palm Springs, CA (US)

Correspondence Address: EDWIN TARVER, 16830 Ventura Blvd., SUITE 360, Encino, CA, 91436, US

(21) Appl. No.: 11/689,784

(22) Filed: Mar. 22, 2007

Related U.S. Application Data
(60) Provisional application No. 60/814,781, filed on Jun. 20, 2006.
(60) Provisional application No. 60/843,098, filed on Sep. 8, 2006.

(51) Int. Cl. A61H 23/04

(52) U.S. Cl. 601/97; 601/105

(57) ABSTRACT

A device for massaging and cleansing. The device comprises a housing, a massaging/cleansing element disposed within the housing, and a means for enabling the element to move rhythmically in a single plane. The enabling means in turn comprises a means for rotating a first portion of the element and a means for translating the rotary motion of the first portion into a linear motion at a second portion of the element thereby producing the overall rhythmic movement. The device further comprises a means for allowing a cleansing/massaging agent to discharge out of the device; the agent to act along with the rhythmic action of the element for producing the massaging/cleansing effect on the skin of a user.

### CROSS-REFERENCE TO RELATED APPLICATION

None

This application claims the priority dates of provisional patent application 60/814,781, filed on Jun. 20, 2006; and provisional patent application 60/843,098, filed on Sep. 8, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to body massaging and cleansing devices and more particularly to a body massaging/cleansing device, which comprises a rhythmically movable massaging/cleansing element for producing a desired massaging/cleansing effect on the skin of a user. The rhythmic movement of the element resembles a figure ‘8’ movement on plan. The device also discharges massaging/cleansing agent during operation.

U.S. Pat. No. 4,919,117 to Muchisky discloses a facial and body massage apparatus. The apparatus comprises an applicator with a handle, and a cleansing/exfoliation element which abuts the skin of a user. The element is constructed to rotate about an axis which is aligned with the handle. The element is also designed to orbit about the axis while rotating, thereby providing maximum surface area contact while reducing heat and skin irritation as well as uneven wear of the element.

U.S. Pat. No. 4,027,348 to Flowers discloses a hand-held portable electrical skin treatment appliance. The appliance includes a means for detachably mounting various skin treatment devices to a rotary drive output. The rotary device abuts the skin of a user for providing cleansing effects thereon.

U.S. Pat. No. 5,129,121 to Gelman discloses a turbine driven rotating brush. The brush comprises a turbine enclosed in a housing, which in turn comprises an inlet for receiving water and an outlet for discharging water flow. A port in the housing directs water onto blades of the turbine. A reduction gear transmits the torque output of the turbine to a shaft on which the brush is mounted. The turbine may be located adjacent a backstop so that water exiting the housing through the outlet is incident on the backstop. The backstop breaks up the discharge of the flow of water outwardly away from the brush for achieving different spray patterns around the brush.

None of the above referenced art incorporates a massaging/cleansing element which is capable of massaging/cleansing over the skin of a user in a rhythm, which resembles a figure ‘8’ movement on plan. This rhythmic movement of the device offers better massaging/cleaning effect on the skin as compared to the other ways offered by the above disclosed art. The objects of the present invention will become better understood with reference to the appended Summary, Description, and Claims.

### SUMMARY

The present invention is a massaging/cleansing device which incorporates a water jet driven turbine, a massaging/cleansing element connected offset of the turbine's central axis so that when the turbine is rotated, a portion of the element connected to the turbine is also rotated. One portion of the turbine is connected with a guide and track mechanism, wherein the guide and track mechanism translates the rotary motion at one end into a linear motion at the other thereby giving rise to an overall rhythmic movement of the element. The element induces the desired massaging/cleansing effect on the skin of a user. The device further comprises a mechanism which releases a foaming massaging/cleansing agent when operated; the agent for producing the massaging/cleansing effect on the skin of a user when acted along with the element.

### BRIEF DESCRIPTION OF THE FIGURES

FIG. 1 is a perspective view of the massaging/cleansing device in accordance with the present invention.

FIG. 2 is a sectional side view of the massaging/cleansing device in accordance with the present invention.

FIG. 3 is a top view of the massaging/cleansing element in accordance with the present invention.

FIGS. 4 through 6 are bottom views of different massaging/cleansing elements in accordance with the present invention.

FIGS. 7 through 9 are side views of different massaging/cleansing elements in accordance with the present invention.

FIG. 10 is a side view depicting the guide and the track arrangement of the massaging/cleansing device in accordance with the present invention.

FIG. 11 is a plan view of the turbine in accordance with the present invention.

FIGS. 12 and 13 are perspective views of the turbine in accordance with the present invention.

FIG. 14 is a plan view of the turbine and the massaging/cleansing element in accordance with the present invention.

FIG. 15 is a perspective view of the turbine and the massaging/cleansing element in accordance with the present invention.

FIG. 16 is a bottom view turbine and the massaging/cleansing element in accordance with the present invention.

FIG. 17 is a side view turbine and the massaging/cleansing element in accordance with the present invention.

### FIGURES—REFERENCE NUMERALS

10 . . . Massaging/cleansing Device
12 . . . Housing
14 . . . Turbine
16 . . . Massaging/cleansing Element
18 . . . Water Jet
20 . . . Massaging/cleansing Pad
22 . . . Connecting Arm
24 . . . Layer of Sponge
26 . . . Layer of Rubber
28 . . . Layer of Bristles
30 . . . Track
32 . . . Tab
34 . . . Blade
36 . . . Hole
38 . . . Central Axis
40 . . . Water Chamber
42 . . . Switch
44 . . . Guide
46 . . . Soap Chamber
48 . . . Plate Member
50 . . . Cap

### DETAILED DESCRIPTION

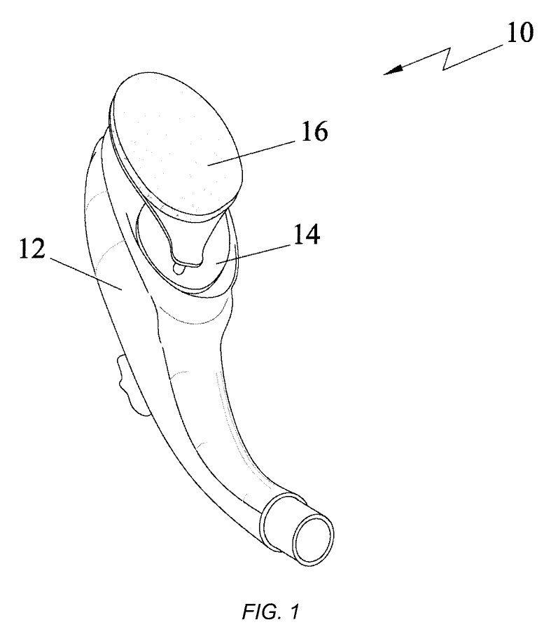

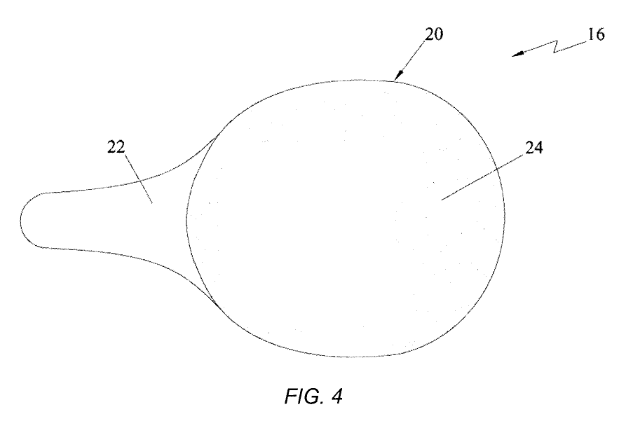

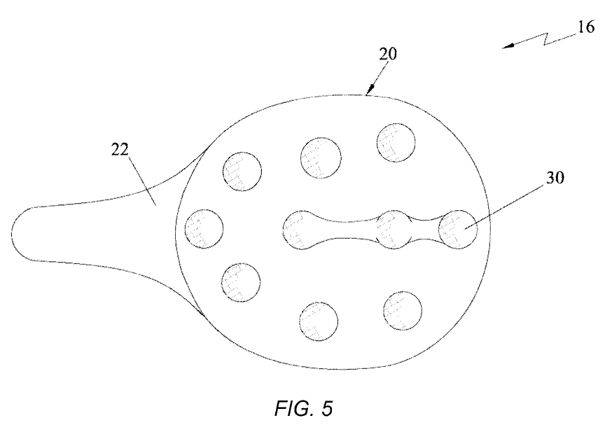

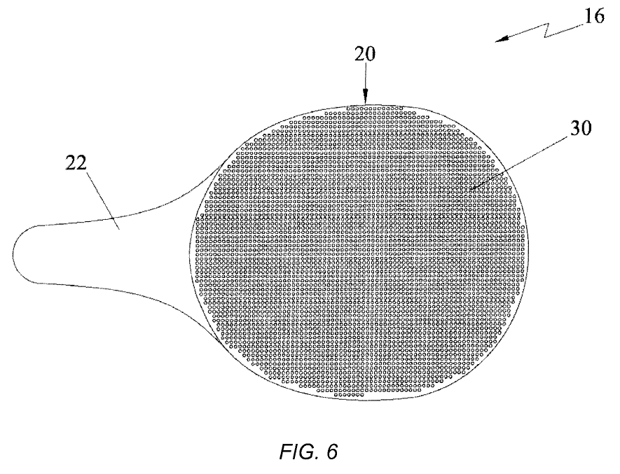

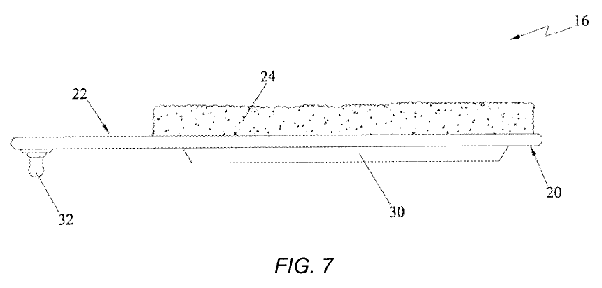

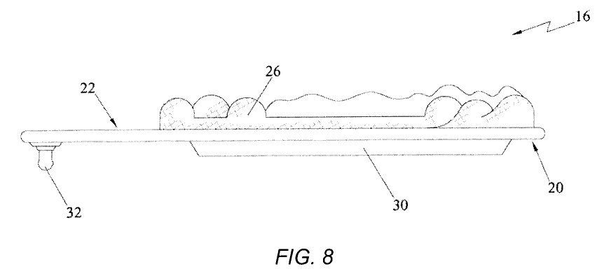

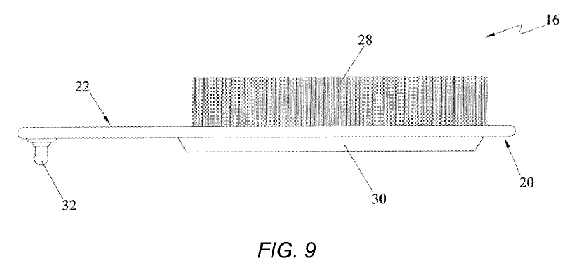

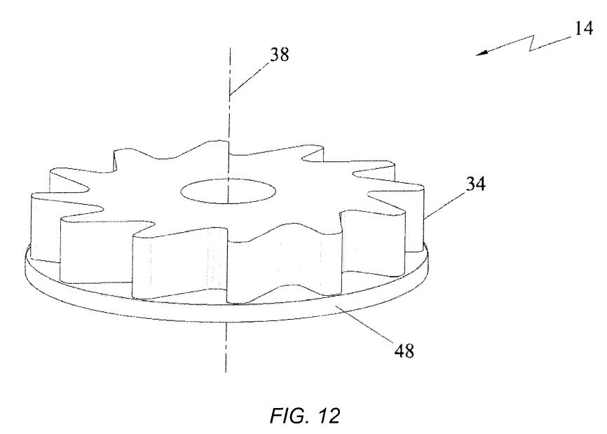

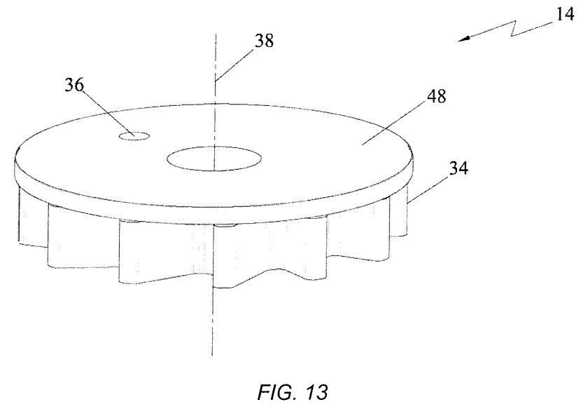

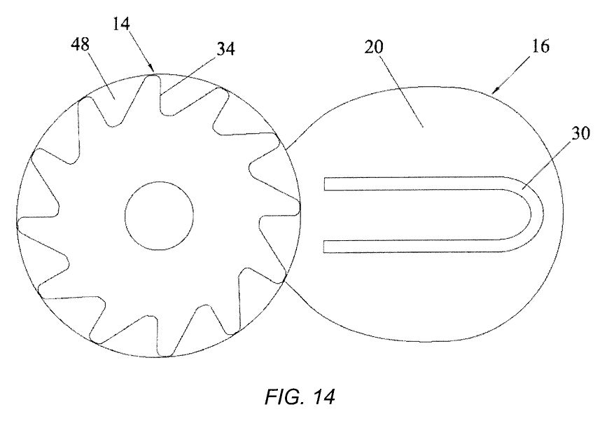

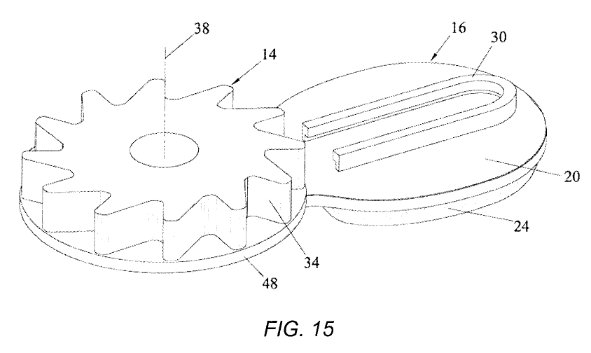

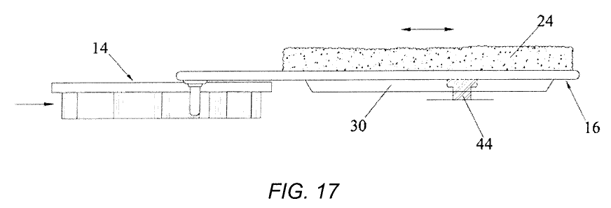

Referring to the drawings, a preferred embodiment of an electrical, handheld massaging/cleansing device, which is also used for skin exfoliation purposes, is illustrated and generally indicated as 10 in FIGS. 1 through 17.

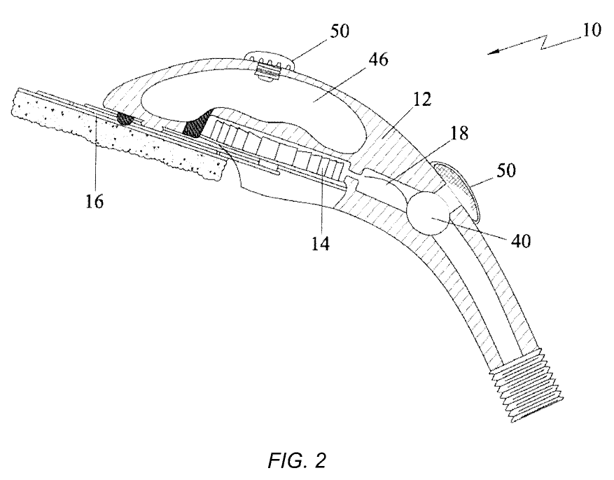

Referring to FIGS. 1 and 2, the device 10 comprises a housing 12, a turbine 14 enclosed within the housing 12, a set of interchangeable massaging/cleansing elements 16, each to be detachably connected to the turbine 14, a water jet 18 disposed within the housing 12 for rotating the turbine 14, and a means for discharging a massaging/cleansing agent from the device 10 when in use.

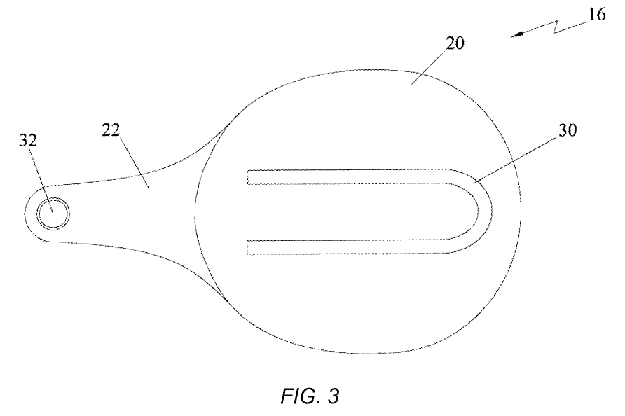

Referring to FIGS. 3 through 9, each massaging/cleansing element 16, which is a flat unitary piece, can be divided into a massaging/cleansing pad 20 and a connecting arm 22 extending from the periphery of the pad 20. The bottom surface of the pad 20 may comprise a layer of sponge 24 for cleansing, a layer of rubber 26 for massaging, or a layer of bristles 28 for scrubbing over the skin of a user. The upper surface of the pad 20 comprises a pair of tracks 30, such that the connecting arm 22 is aligned between the pair of tracks 30 as seen in FIG. 3. The pad 20 can be substantially circular, elliptical, or oblong on plan. The upper surface of the connecting arm 22 is attached with a tab 32.

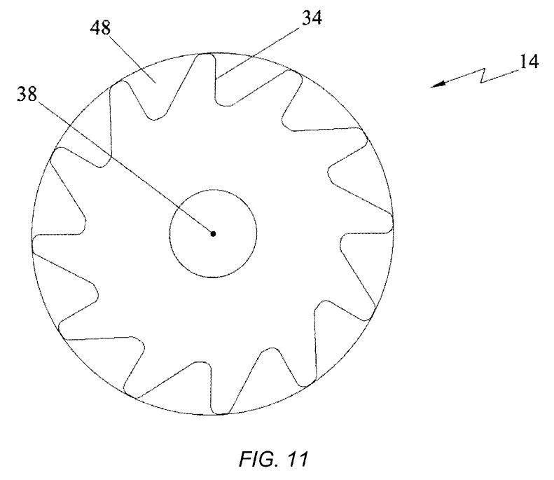

Referring to FIGS. 11 through 16, the turbine 14 resembles a gear wheel. The blades 34 of the turbine 14 are uniformly slanted in one direction. The top and bottom surfaces of the turbine 14 are substantially flat. The bottom surface of the turbine 14 comprises a circular plate member 48 concentric to the turbine 14. The turbine 14 further comprises a hole 36 at its bottom surface through the plate member 48 for detachably receiving the tab 34 of the connecting arm 22. The hole 36 is offset of the central axis 38 about which the turbine 14 is rotated. Therefore, when the turbine 14 is rotated, the connecting arm 22 also rotates along.

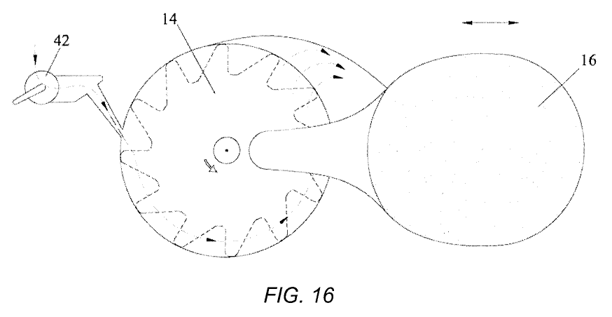

Referring to FIGS. 2 and 16, the water from the water jet 18 is impinged on the blades 34 of the turbine 14 in a direction substantially opposite to the direction of the slant of the blades 34. The plate member 48 prevents the water from discharging directly from the blades 34 of the turbine 14. The water can be sourced either from an external source or from a water chamber 40 enclosed within the housing 12. The water chamber 40 can be accessed by a cap 50 fitted over it. The water jet 18 can be electrically activated and deactivated by a switch 42.

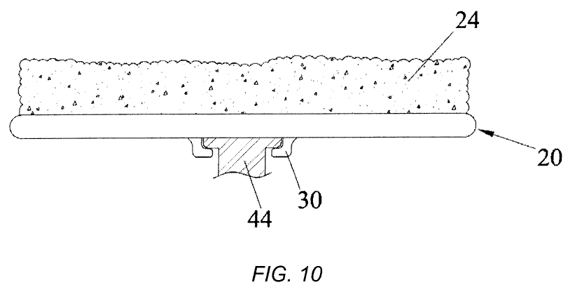

Referring to FIGS. 10, 16, and 17, a guide 44, disposed within the housing 12, is to be received within the pair of tracks 30 such that the tracks 30 can reciprocate about the guide 44. Therefore, as the connecting arm 22 rotates, the pad 20 reciprocates due to the mutual arrangement of the guide 44 and the tracks 30. The rotary motion of the connecting arm 22 and the reciprocatory motion of the pad 20 together make up the overall movement resembling a rhythmic figure ‘8’ movement on plan.

Referring to FIGS. 1 and 2, the housing 10 further comprises a soap chamber 46 for containing liquid soap; the soap chamber 46 disposed above the turbine 14. The liquid soap can be refilled into the soap chamber 46 through an opening fitted with a cap 50. The housing 12 is also provided with a mechanism for discharging the liquid soap over the turbine 14. The discharged liquid soap and the water become miscible forming the massaging/cleansing agent. Foam is produced when the pulsating water particles and the liquid soap are mixed together. Except for the bottom surface of the pad 20, all the components of the device 10 are enclosed within the housing 12 as seen in FIG. 1.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A massaging/cleansing device comprising:
(a) a housing;
(b) a massaging/cleansing element disposed within the housing;
(c) a means for enabling the element to move rhythmically in a single plane, the enabling means in turn comprising a means for rotating a first portion of the element and a means for translating the rotary motion of the first portion into a linear motion at a second portion of the element thereby producing the overall rhythmic movement, the enabling means enclosed within the housing; and
(d) a means for causing a cleansing/massaging agent to discharge from the device, the agent to act along with the element for producing the massaging/cleansing effect on the skin of a user.

2. The device of claim 1 being handheld.

3. The device of claim 1, wherein the element is replaceable.

4. The device of claim 1, wherein the element is flat.

5. The device of claim 4, wherein the bottom surface of the element comprises a layer of sponge for producing a cleaning effect on the skin of a user.

6. The device of claim 4, wherein the bottom surface of the element comprises a layer of rubber for producing a massaging effect on the skin of a user.

7. The device of claim 4, wherein the bottom surface of the element comprises a layer of bristles for producing a scrubbing effect on the skin of a user.

8. The device of claim 1, wherein the element can be divided into a massaging/cleansing pad and a connecting arm.

9. The device of claim 8, wherein the pad is substantially circular on plan.

10. The device of claim 9, wherein the connecting arm extends from the periphery of the pad.

11. The device of claim 8, wherein the pad is substantially oblong or elliptical on plan.

12. The device of claim 11, wherein the connecting arm extends from the periphery of the pad such that the longitudinal axis of the pad coincides with that of the connecting arm.

13. The device of claim 8, wherein the connecting arm refers to the first portion of the element, and the pad refers to the second portion of the element.

14. The device of claim 8, wherein the connecting arm includes a tab attached on its top.

15. The device of claim 1, wherein the rotating means comprises a turbine connected within the housing, the turbine is operated by impinging a fluid upon it from a fluid jet; the element is connected to the turbine such that first portion of the element is rotated along with the turbine.

16. The device of claim 15, wherein the fluid comprises water.

17. The device of claim 15, wherein the first portion of the element is detachably connected to the turbine offset of the central axis.

18. The device of claim 17, wherein the first portion is connected to the turbine by a tab which is received within a hole in the turbine.

19. The device of claim 18, wherein the hole is located at the bottom of the turbine.

20. The device of claim 15, wherein the fluid is sourced from a fluid chamber located within the housing.

21. The device of claim 15, wherein the turbine resembles a gearwheel.

22. The device of claim 15, wherein the blades of the turbine are uniformly slanted in one direction.

23. The device of claim 22, wherein the fluid is impinged on the turbine in a direction opposite to the direction of the slant of the turbine blades of the turbine.

24. The device of claim 15, wherein the bottom surface of the turbine abuts a plate member; the plate member prevents the discharge of the fluid form the blades of the turbine.

25. The device of claim 24, wherein the plate member is concentric with the turbine.

26. The device of claim 24, wherein the plate member is circular.

27. The device of claim 1, wherein the translating means comprises a pair of tracks disposed over the second portion of the element and an engaging guide connected to the housing and slidably received within the tracks; the tracks to reciprocate about the guide as the first portion of the element is rotated.

28. The device of claim 1, wherein the housing comprises a soap chamber for containing liquid soap; the liquid soap is discharged from its chamber as the device is being operated.

29. The device of claim 1, wherein the liquid soap is discharged over the turbine.

30. The device of claim 1, wherein the overall rhythmic movement of the element resembles a figure “8” movement on plan.

31. The device of claim 1, wherein the agent comprises a mixture of water and liquid soap.
